(19) United States
(12) Patent Application Publication
(10) Pub. No.: US 2026/0142301 A1
(43) Pub. Date: May 21, 2026

(54) PRODUCTION LINE FOR MANUFACTURING BATTERY HOUSING PARTS AND METHOD FOR MANUFACTURING BATTERY HOUSING PARTS

(71) Applicant: Nemak, S.A.B. de C.V., García, Nuevo León (MX)

(72) Inventors: Christopher WICKERT, Frankfurt am Main (DE); Stefan MARSCH, Overath (DE)

(21) Appl. No.: 19/481,675

(22) PCT Filed: Apr. 24, 2024
(86) PCT No.: PCT/IB2024/053987

§ 371 Date: Nov. 5, 2025

(30) Foreign Application Priority Data
May 9, 2023 (EP) 23172207.5

(51) Int. Cl. H01M 50/249; H01M 10/615; H01M 10/625; H01M 10/63; H01M 50/264

(52) U.S. Cl. CPC H01M 50/249; H01M 10/615; H01M 10/625; H01M 10/63; H01M 50/264

(57) ABSTRACT

The invention relates to a production line for manufacturing battery housing parts, in particular battery trays, for electrically powered vehicles, comprising: at least one storage station for storing battery housing receptacles and frames for the battery housing part to be manufactured; at least one connection station for connecting the battery housing receptacles to the frames by means of a foam material and/or an adhesive; preferably at least one intermediate storage unit for storing the battery housing receptacles connected to a frame; at least one storage unit for storing base plates for the battery housing parts to be manufactured; at least one joining station for the material-locking connection of battery housing receptacles, in particular battery housing receptacles connected to frames, with base plates by means of at least one foam material and/or at least one adhesive; and at least one storage warehouse for storing the battery housing parts.

### CROSS-REFERENCE TO RELATED APPLICATIONS

This application claims priority to PCT International Application No. PCT/IB2024/053987 filed on Apr. 24, 2024, which claims priority to European Patent Application No. 23172207.5 filed on May 9, 2023, the entire disclosures of which are expressly incorporated herein by reference.

### STATEMENT RE: FEDERALLY SPONSORED RESEARCH/DEVELOPMENT

Not Applicable

### BACKGROUND

The present invention relates to a production line for manufacturing battery housing parts, in particular battery trays, for electrically powered vehicles, comprising: at least one storage station for storing battery housing receptacles and frames for the battery housing part to be manufactured; at least one joining station for joining the battery housing receptacles to the frames by means of a foam material and/or an adhesive; preferably at least one intermediate storage unit for storing the battery housing receptacles joined to a frame; at least one storage unit for storing base plates for the battery housing parts to be manufactured; at least one joining station for joining battery housing receptacles, in particular battery housing receptacles connected to frames, to base plates by means of at least one foam material and/or at least one adhesive; and at least one storage warehouse for storing the battery housing parts. Furthermore, the present invention relates to a method for manufacturing battery housing parts, in particular battery trays, for electrically powered vehicles.

Electrically powered vehicles of the type in question here usually carry a plurality of battery modules comprising battery cells, which serve as drive energy storage devices and provide the electrical energy required for driving. In particular, an electrically powered vehicle of the type discussed here is an electric car, which is essentially powered exclusively by one or more electric motors. Alternatively, the aforementioned battery housing part can also be used in a hybrid vehicle, which has a combustion engine in addition to an electric motor.

In terms of driving performance, placing the individual battery modules in the floor area of the vehicle has proven to be effective. To make this possible, battery housing parts have been proposed that are essentially flat and plate-like in design. Such battery housing parts can be arranged in the floor area of the vehicle and connected to the vehicle body.

Accordingly, considerable demands are placed on battery housing parts and battery housings. Battery housing parts, such as a battery tray in particular, should not only support the individual battery modules or battery cells, but also ensure sufficient safety while the vehicle is in operation.

Accordingly, such battery housing parts should, on the one hand, absorb dynamic loads sufficiently and, on the other hand, prevent the individual battery modules or individual battery cells from overheating. In order to dissipate the heat generated during driving, it is known from the prior art to provide the battery housing parts in question with a cooling device that reliably dissipates the heat released during charging and discharging of the battery modules or battery cells.

However, cooling devices arranged in the battery housing parts sometimes lead to complex manufacturing processes for the individual battery housing parts and can also cause adverse dynamic properties during vehicle operation.

Against this background, the present invention is based on the task of specifying a production line for manufacturing battery housing parts and a method for the manufacture of battery housing parts, which enable cost-effective production of battery housing parts, whereby the battery housing parts have advantageous mechanical properties.

### BRIEF SUMMARY

According to a first aspect of the present invention, the aforementioned task is solved in a production line for manufacturing battery housing parts, in particular battery trays, for electrically powered vehicles, in that the production line further comprises at least one climate control device, and in that the at least one climate control device tempers battery housing receptacles, frames, and/or base plates, preferably depending on the open time and/or the curing time of the foam material and/or the adhesive.

The aforementioned production line makes it possible to provide a production line with a favorable design that enables short production cycles and an advantageous material bond between the individual components.

The open time of the foam material and/or adhesive is, in particular, the period of time from the start of application of the foam material and/or adhesive to the joining or bonding of the parts to be joined. The curing time refers in particular to the time during which the foam material and/or adhesive reaches a strength such that the components to be joined are connected to each other in such a way that they are secure for handling and the joining partners can be handled without shifting relative to each other.

It is preferable that the temperature of the battery housing components to be joined, in particular the temperature of the battery housing receptacles, the frames, and/or the base plate, and/or the temperature of the foam material and/or the adhesive is within a preferred range of 25° C. to 55° C., in particular within a range of 27° C. to 50° C., during the manufacturing process. It is particularly preferred that the process temperature during the manufacturing process is in a range from 25° C. to 55° C., in particular in a range from 27° C. to 50° C., wherein the process temperature is in particular the temperature of the components to be joined, i.e. the temperature of the battery housing receptacles, the frames, and the base plate. The process temperature may also be the temperature prevailing at the respective stations of the production line.

Preferably, the process temperature is subject to only minor fluctuations during the manufacturing process, in particular only fluctuations in a range of 5° C., particularly preferably only fluctuations in a range of 2.5° C., so that external influences during the manufacturing process can be minimized.

It is preferable that the at least one climate control device can both cool and heat. For example, the use of an exothermic foam material may necessitate cooling in order to regulate the resulting thermal balance and adjust the process temperature range during the manufacturing process.

Furthermore, it is preferable that the individual stations of the production line are temperature-controlled to different temperature ranges. This allows the different requirements of the respective stations to be taken into account.

The base plate is preferably an essentially plate-shaped part, in particular an essentially plate-shaped sheet metal. It is also conceivable that only part of the base plate is plate-shaped and another area of the base plate has, for example, a projecting area and/or an angled area.

The battery housing receptacle serves in particular to enable at least one battery cell and/or at least one battery module to be arranged at least partially in or on the battery housing receptacle. The at least one battery cell and/or the at least one battery module can be arranged both directly and indirectly on or in the battery housing receptacle.

The battery housing receptacle has a substantially plate-shaped bottom section on which the at least one battery cell and/or the at least one battery module can be arranged directly or indirectly. The plate-shaped bottom section can, for example, be provided in the form of a substantially plate-shaped sheet metal. However, the plate-shaped bottom section can also have embossings and/or angled areas.

Preferably, a plurality of channels, in particular cooling channels, are arranged on the surface of the plate-shaped bottom section. Such channels can be formed by embossed and/or punched sheets or sheet metal parts. Furthermore, it is preferable that the embossed and/or punched metal sheets or metal sheet parts are soldered, in particular oven-soldered, to the plate-shaped bottom section of the battery housing receptacle. This enables a reliable connection and a reliable seal between the plurality of channels and the essentially plate-shaped bottom section of the battery housing receptacle, whereby the essentially plate-shaped bottom section with the plurality of channels can also be provided cost-effectively on one surface.

It is also preferred that the plurality of channels extend substantially over an entire plate-shaped surface of the plate-shaped bottom section. Alternatively, it is also possible for the plurality of channels to extend only over certain areas of the surface of the plate-shaped bottom section. Preferably, the plurality of channels is arranged on a substantially flat and/or plate-shaped surface of the plate-shaped bottom section of the battery housing receptacle, in particular soldered thereto.

A further preferred embodiment is characterized in that the at least one climate control device maintains the battery housing receptacle, frame, and/or base plates within the entire production line or during the entire production process in a process temperature range between 25° C. and 55° C., in particular between 27.5° C. and 50° C. and particularly preferably between 30° C. and 45° C. Such process temperature ranges have proven to be advantageous, particularly with regard to short cycle times, whereby sufficient strength of the material-locking connections of the components to be joined can nevertheless be achieved.

In a further preferred embodiment, the production line is at least partially enclosed by at least one housing, whereby the temperature within the at least one housing is set to the process temperature range. This allows a constant temperature to be maintained within the area of the production line enclosed by the housing in a particularly simple design. In this context, it is further preferred that a process temperature range between 25° C. and 35° C. is set within the area enclosed by the housing.

A further preferred embodiment is characterized in that the at least one storage station, the at least one intermediate storage and/or the at least one storage warehouse are temperature-controlled by means of storage climate elements to a storage temperature in a range from 25° C. to 50° C., in particular in a range from 30° C. to 45° C. This makes it possible to provide components that have already been temperature-controlled in the storage facilities, thus taking into account the open time and/or the curing time of the foam material and/or the adhesive. In particular, shorter process times for manufacturing a battery housing part can be made possible, thereby increasing the productivity of the production line. Preferably, the storage temperature provided is a temperature that prevails in a storage area of the storage station, the intermediate storage warehouse, and/or the storage warehouse.

Furthermore, it is preferable that the storage station, the intermediate storage warehouse, and/or the storage unit are essentially tower-shaped. Preferably, 50 to 120 components, in particular 80 to 100 components, can be stored in the storage station and in the intermediate storage warehouse. Preferably, the intermediate storage has a storage capacity of 10 to 30 components, in particular 15 to 25 components.

In a preferred embodiment, the storage station has at least two storage areas, wherein the battery housing receptacles can be stored in a first storage area of the storage unit and wherein the frames can be stored in a second storage area of the storage unit.

A further preferred embodiment is characterized in that the production line further comprises at least one adhesive station, in that the adhesive station applies at least one adhesive seam to the battery housing receptacles and/or frames provided by the storage station, in that the adhesive station is tempered to the process temperature range, and in that the adhesive station preferably applies the adhesive before the at least one adhesive seam is applied. the frames, that the adhesive station is tempered to the process temperature range, and that the adhesive station preferably tempers the adhesive before applying the at least one adhesive seam, in particular to a temperature between 25° C. and 50° C., particularly preferably to a temperature between 27.5° C. and 35° C.

By tempering the adhesive station to the process temperature range and/or tempering and/or heating the adhesive before applying the at least one adhesive seam, an advantageous open time of the adhesive can be taken into account, so that the at least one adhesive seam can effect reliable adhesion or cohesion. For example, the adhesive station comprises two gluing robots, each of which applies a adhesive seam to the battery housing receptacles and/or the frames provided by the storage station. Preferably, at least one gluing robot of the adhesive station has climate control elements, in particular Peltier heating elements, for temperature control/heating of the adhesive.

Another preferred embodiment is characterized in that the at least one connection station is designed as at least one rotary table comprising a plurality of receiving areas, that the at least one rotary table has at least one connection station climate element per receiving area, and that the connection station climate elements temper the temperature of the battery housing receptacles and/or the frames to the process temperature range, in particular to a process temperature range between 40° C. and 50° C. Preferably, the connection station climate elements can also temper a temperature prevailing in the receiving areas to the process temperature range, in particular to a process temperature range between 40° C. and 50° C.

At least one rotary table can be used to provide a connection station that connects battery housing receptacles and frames to each other in a structurally simple manner. For example, a battery housing receptacle is first placed in a receiving area of the rotary table by means of a manipulation robot. The battery housing holder stored in the holder area can then be rotated into a second position, in which a frame can be joined to the battery housing holder by another manipulation robot. Temperature control enables advantageous joining, taking into account the behavior of the adhesive.

Another preferred embodiment is characterized in that the plurality of receiving areas each have at least one alignment means, in particular a vacuum alignment means, for aligning the battery housing receptacles, and/or that the plurality of receiving areas each have at least one fixing means for fixing the battery housing receptacles. This enables precise alignment of the battery housing receptacles in the receiving areas and reliable fixation of the battery housing receptacles in the receiving areas, so that the battery housing receptacles can be connected precisely to the frames.

In a further embodiment, the production line also comprises at least one casting station, wherein the at least one casting station casts the battery housing parts connected to a frame with a foam material and/or a casting agent. The use of the foam material and/or the casting agent enables an advantageous strength of the connection between the battery housing parts and the frame. In addition, the tightness of the connection between the frame and the battery housing parts can be increased. Furthermore, it is preferred that the at least one potting station pots the battery housing parts and frames arranged in the receiving areas and already connected to each other by means of an adhesive seam.

It is also preferable that the sealing agent and/or the casting agent is only applied once the at least one frame has already been glued and/or clamped to the at least one battery housing receptacle. In such a case, the joint gap to be sealed or potted is first measured, then the filling quantity in the individual areas is determined, and then the sealing agent and/or the potting agent is applied.

A further preferred embodiment is characterized in that the production line also comprises at least one adhesive and foam station, that the adhesive and foam station applies adhesive and/or foam material to the battery housing receptacles connected to a frame provided by the intermediate storage, and that the adhesive and foam station is tempered to the process temperature.

By tempering the adhesive and foam station to the process temperature range, an advantageous open time of the adhesive and/or foam material can be taken into account, so that reliable adhesion or cohesion can be achieved. For example, the adhesive and foam station comprises four stations, namely a loading station for receiving the battery housing receptacles provided by the intermediate storage and connected to a frame, an adhesive station, a foam material station, and an unloading station. Preferably, at least one adhesive robot of the adhesive station has climate elements, in particular Peltier heating elements, for temperature control/heating of the adhesive.

A further preferred embodiment is characterized in that the gluing and foaming station tempers the adhesive and/or the foam material before application to a temperature range, in particular to a process temperature range, between 25° C. and 50° C., particularly preferably between 27.5° C. and 35° C. Such temperature control of the adhesive and/or foam material has proven to be particularly advantageous in practice with regard to the open time or the adhesion or cohesion provided by the adhesive and/or foam material. In addition, this enables preferred cycle times for the production line.

A further preferred embodiment is characterized in that the joining station presses the battery housing receptacles connected to the frame and the base plates together by means of at least one pressure pad, in particular by means of at least one pressure hose, and that the at least one pressure pad, in particular the at least one pressure hose, can be supplied with tempered air, in particular tempered compressed air, to adjust the process temperature range in the joining station. By the joining station connecting battery housing receptacles and base plates to each other in a material-locking manner with at least one pressure pad with tempered air, a thermal balance can be set in the joining station which is advantageous in terms of the open time and/or the curing time of the foam material and/or the adhesive. In particular, this can enable reduced cycle times.

By using at least one pressure pad, a substantially homogeneous or uniform pressure can be applied to the components to be joined, namely the base plate and the battery housing holder, so that sufficient joining is ensured. In particular, this can counteract the pressures that occur during bonding, which arise, for example, due to a reaction of the adhesive and/or the foam material.

The at least one pressure pad can be made of a flexible solid material, in particular a soft elastic material such as rubber or silicone. The pressure pad can also be an expandable or inflatable pressure pad, such as a pneumatically inflatable or hydraulically expandable pad, wherein the pad cover can be made of rubber or silicone, for example. Preferably, the use of at least one pressure pad can achieve improved pressure distribution or force distribution. Furthermore, it is preferable that the at least one pressure pad has a fabric.

In a preferred embodiment, the at least one pressure pad presses the battery housing receptacles against the base plates indirectly via at least one pressure unit. Indirect application by means of at least one pressure unit can prove advantageous in that the pressure distribution or force distribution is further improved during the pressing step. Preferably, indirect application is carried out by means of at least one pressure unit. The pressure unit can be, for example, a pressure plate, in particular a metallic pressure plate.

In a preferred embodiment, the at least one pressure pad can be pressurized and/or filled with compressed air, wherein the applied pressure is indicative of the contact force exerted by the at least one pressure pad and/or the contact pressure exerted by the at least one pressure pad. This enables reliable joining, in particular reliable bonding, of the base plate and battery housing receptacle. Preferably, the level of pressure applied to the at least one pressure pad is adjustable and/or controllable. This enables precise adjustment of the pressing force or pressing pressure exerted, so that advantageous joining between the base plate and the battery housing receptacle can be achieved. Advantageously, the pressure of the at least one pressure pad can be maintained and/or changed during the joining step, so that reliable curing or gelling of an adhesive and/or a foam material can be enabled over a certain period of time. Preferably, the at least one pressure pad is designed to withstand a pressure of up to 18 bar. In particular, it has proven advantageous to provide a pressure of up to 10 bar, in particular up to 6 bar, during the joining step. The aforementioned pressures can provide advantageous locking forces, so that pressure and/or heat developments of the adhesive and/or foam material can be counteracted during a thermoreactive phase of the adhesive and/or foam material.

In a further preferred embodiment, the at least one pressure pad is designed as at least one pressure hose, in particular as at least one fabric pressure hose, and/or the at least one fabric pressure hose can be pressurized or filled with tempered air, in particular tempered compressed air. Preferably, the at least one pressure hose has a woven, textile outer shell and a rubberized inner shell. This allows the battery housing receptacles and base plates to be connected in a favorable manner with tempered compressed air. For example, a thermal balance can be established that is advantageous in terms of the open time and/or curing time of the foam material and/or adhesive. In particular, this can enable reduced cycle times. The aforementioned pressure hoses also have high flexibility, advantageous rot resistance and maintenance properties, and good cold resistance. The aforementioned pressure hoses may in particular be commercially available fire hoses.

Furthermore, it is preferable that the temperature prevailing in the joining station during the joining process is measured by means of at least one sensor and that the quantity and/or temperature of the tempered air is controlled by a control means depending on the temperature measured by the at least one sensor. This allows the desired temperature range, in particular the process temperature range, to be reliably set during the joining step.

Preferably, the joining station comprises at least one upper and movable tool half for fixing and manipulating at least one base plate; at least one lower tool half comprising at least one pressure unit and at least one pressure pad for joining the at least one base plate and at least one battery housing receptacle; wherein the at least one battery housing receptacle comprises at least one substantially plate-shaped bottom section and wherein the substantially plate-shaped bottom section comprises a plurality of channels on one surface, wherein the joining station further comprises at least one climate control means, so that the at least one pressure pad can be supplied with or filled with tempered air, in particular tempered compressed air.

It is preferred that the tempered air, in particular the tempered compressed air, has a temperature that is above the ambient temperature. In particular, the tempered compressed air has a temperature of above 25° C., in particular above 35° C., and particularly preferably above 45° C.

It is also preferred that at least one pressure pad is provided, wherein the at least one pressure pad is filled substantially uniformly with compressed air, in particular with heated compressed air, and thus exerts a uniform pressing force on the battery housing receptacle and/or the base plate. This allows pressures and/or heat developments arising during the joining process to be compensated for, which may occur, for example, during the thermoreactive phase of the adhesive and/or the foam material. By operating with heated compressed air, the heating in the lower half of the tool can be supported calorically.

Preferably, the upper mold half fixes the base plate via a vacuum unit so that it can be aligned and fixed in an advantageous manner. To position the base plate and battery housing holder, the upper mold half can be moved, in particular hydraulically, until the base plate held by the upper mold half essentially rests against the battery housing holder. A corresponding position can then be locked in place mechanically, for example, using bolts. For example, the base plate and the battery housing receptacle connected to the frame can also be locked in place hydraulically. The pressure required for the further joining process can then be provided by the at least one pressure pad.

Furthermore, it is preferable that the at least one pressure pad be filled with tempered air, whereby a pressing pressure can build up uniformly and at a controlled temperature to counteract the pressure of the adhesive and/or the foam material. Appropriate temperature control can reduce the cycle time of the joining process and also enable essentially robust parameters of the joining process regardless of the ambient temperature. The tempered air, in particular the tempered compressed air, can be, for example, heated or cooled air. In addition, the tempered air can be used to set a uniform temperature profile in the tool, which prevents distortion of the components to be joined, so that manufacturing tolerances can be reliably maintained.

Preferably, the upper tool half is first pivoted, for example by means of at least one hinge attachment. When a minimum distance between the base plate to be joined and the battery housing receptacle is reached, the upper tool half is then moved essentially vertically and/or linearly. In particular, the upper tool half is moved in such a way that the at least one base plate and the at least one battery housing receptacle are moved toward each other in a plane-parallel manner. This advantageously prevents shearing of the connection between the battery housing receptacle, frame, and/or base plate. Such a design has also proven to be advantageous in that the air remaining in the device can be minimized, so that the joining process of the base plate and battery housing receptacle can be further improved. Preferably, the aforementioned minimum distance is in the range of 20 cm to 40 cm.

After the essentially vertical, linear, and/or plane-parallel movement of the upper tool half, it is placed on a locking device and/or locked by means of a locking device. For example, this may be a hydraulic and/or mechanical locking device.

A further preferred embodiment is characterized in that the foam material and/or the adhesive comprises a multi-component system, in particular a two-component system, or is designed as a multi-component system, in particular as a two-component system. The multi-component system, in particular the two-component system, may consist of two different materials or comprise two different materials which can be mixed in a specific ratio to trigger a chemical reaction leading to curing or cross-linking.

For example, the multi-component system may be a resin-hardener combination, wherein the resin may be a liquid, reactive component and the hardener may be a solid or liquid component that triggers a chemical reaction when mixed with the resin. The resin and hardener are preferably chemically inert and stable until they are mixed. After mixing, the multi-component system can then cure quickly, robustly, and reliably, thus providing the aforementioned functional properties of the foam material and/or adhesive.

The aforementioned task is solved according to a second aspect of the present invention by a method for manufacturing battery housing parts, in particular battery trays, for electrically powered vehicles, wherein the method comprises the following steps: storing battery housing receptacles, frames, and/or base plates; joining the battery housing receptacles, frames, and/or base plates to each other by means of at least one foam material and/or at least one adhesive; tempering the battery housing receptacles, frames, and/or base plates and/or tempering the foam material and/or the adhesive to a process temperature range.

The advantages associated with the aforementioned method have already been explained above with reference to the production line according to the invention.

One embodiment is characterized in that the tempering to a process temperature range is carried out essentially throughout the entire process, and/or that the process temperature range is preferably in a range from 25° C. to 55° C., in particular in a range from 27° C. to 50° C.

Preferably, the process is carried out using a production line according to the first aspect.

The embodiments and exemplary configurations of all aspects of the invention described above, which are initially fundamentally independent of each other, are also to be understood as disclosed in all combinations with each other.

Further advantageous exemplary embodiments of the invention can be seen in the following detailed description of some exemplary embodiments of the present invention, in particular in conjunction with the figures. However, the figures accompanying the application are intended only for the purpose of clarification and not for determining the scope of protection of the invention. The accompanying drawings are not necessarily to scale and are intended only to reflect the general concept of the present invention by way of example. In particular, features included in the figures should in no way be considered an essential part of the present invention.

### BRIEF DESCRIPTION OF THE DRAWINGS

The invention is explained in more detail below with reference to drawings showing examples of embodiments. Each of the following shows schematically:

FIG. 1 a schematic view of an example of a production line;

FIG. 2 a schematic view of an embodiment of a joining station of a production line and an embodiment of a battery housing part arranged in the joining station; and

FIG. 3 a schematic view of the embodiment of the battery housing part manufactured by means of the production line.

### DETAILED DESCRIPTION

In the following description of the various embodiments according to the invention, components and elements with the same function and the same mode of operation are assigned the same reference numerals, even if the components and elements may differ in their dimensions or shape in the various embodiments.

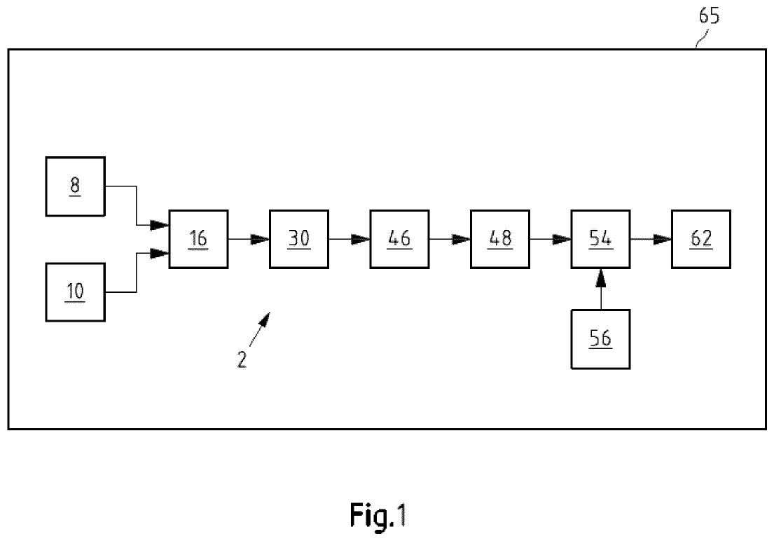

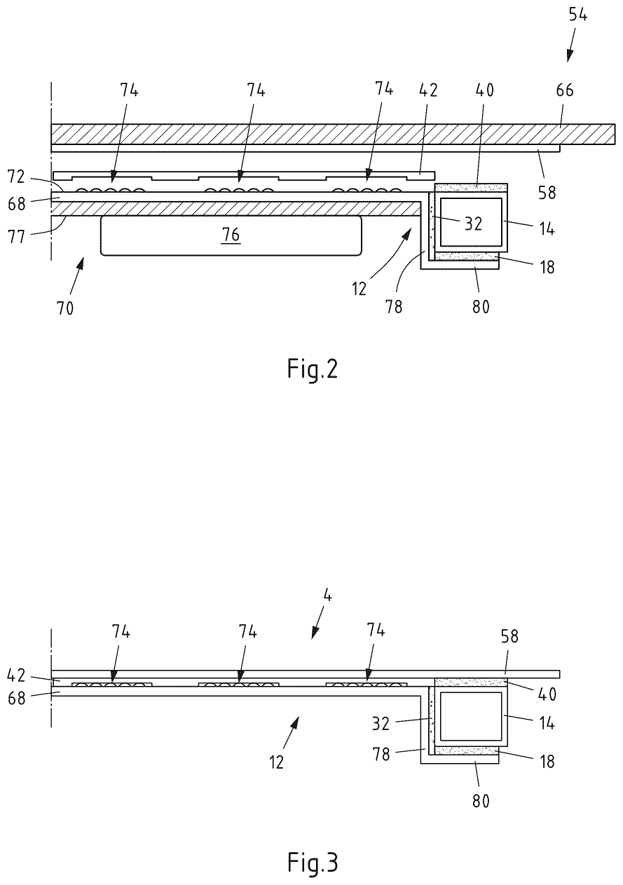

FIG. 1 shows a schematic view of an embodiment of a production line 2. The production line 2 is designed for manufacturing battery housing parts 4.

The production line 2 comprises a storage station which has two storage areas 8 and 10. The two storage areas 8 and 10 are designed, for example, as high-bay warehouses.

Storage area 8 is designed to accommodate battery housing receptacles 12. Preferably, storage area 8 has at least one climate control element for maintaining the temperature of storage area 8 within a process temperature range. In particular, storage area 8 is maintained at a temperature between 30° C. and 45° C. during operation of production line 2.

The storage area 10 is designed to store frames 14 for the battery housing parts 4 to be manufactured. Preferably, the storage area 10 has at least one climate control element for controlling the temperature of the storage area 10 to a process temperature range. In particular, the storage area 10 is temperature-controlled to a temperature range between 30° C. and 45° C. during operation of the production line 2.

The production line 2 also has an adhesive station 16 connected to the storage area 10, wherein the adhesive station 16 applies adhesive seams 18 to the frames 14 provided by the storage area 10. For this purpose, the storage area 10 and the adhesive station 16 are connected to each other, for example by means of a conveyor belt. For example, several adhesive stations 16 may also be provided so that adhesive seams 18 can be applied at different positions on the frame 14.

Preferably, the adhesive station 16 is tempered to the process temperature range and/or the adhesive is tempered to a temperature or temperature range.

The battery housing receptacles 12 provided by storage area 8 are transferred, for example by means of a manipulation robot, to a first position of a receiving area of a connection station designed as a rotary table. The rotary table has a total of several receiving areas, the position of which can be changed by rotating the rotary table.

The battery housing receptacles and the frames can be connected to each other in a material-locking manner by means of the rotary table. For this purpose, a further manipulation robot can arrange the frames 14, which are provided with at least one adhesive seam 18, precisely on the battery housing receptacles 12 in a second position of the receiving areas.

A casting station 30 is arranged in a next position of the receiving areas, which casts the battery housing receptacles 12 already connected to the frames 14 with a foam casting material 32.

In the other positions of the rotary table, the battery housing receptacles 12 connected to the frames 14 are not further processed so that the adhesive 18 and/or the foam material 32 can cure.

In a final position, the battery housing parts 12 connected to the frames 14 are removed by another manipulation robot and fed to an intermediate storage warehouse for storing the battery housing receptacles 12 connected to the frames 14. The intermediate storage warehouse is temperature-controlled to a range between 27.5° C. and 32.5° C.

Joining station climate elements are preferably arranged in the receiving areas, which maintain the receiving areas at the process temperature range, in particular at a temperature range between 40° C. and 50° C., during operation of the production line.

The production line 2 also comprises an adhesive and foam station, which applies adhesive 40 and foam material 42 to the battery housing receptacles 12 provided by an intermediate storage unit and connected to a frame 14. For this purpose, the adhesive and foam station comprises, for example, a conveyor belt and an adhesive application device 46 for applying the adhesive 40 and a foam application device 48 for applying the foam material 42. Preferably, the adhesive and foam station has at least one climate control element by means of which the process temperature range can be provided in the adhesive and foam station. It is also preferable that the adhesive and foam station tempers the adhesive 40 and/or the foam material 42 to a temperature between 25° C. and 50° C., particularly preferably between 27.5° C. and 35° C., before application.

By means of a further conveyor belt, the battery housing receptacles 12 provided with adhesive 40 and foam material 42 are fed via a conveyor section to at least one joining station 54.

In addition, a storage unit 56 is provided for storing base plates 58 to be connected to the battery housing receptacles 12. This storage unit 56 also preferably has climate control elements for tempering the storage unit 56 to the process temperature range. The base plates 58 can be fed to the joining station 54 for connection to the battery housing receptacles 12 by means of a manipulation robot and a conveyor line. After joining the battery housing receptacles 12 and base plates 58, the battery housing parts 4, in particular the battery trays, are removed and fed to a final storage 62 by means of a further manipulation robot, wherein the final storage 62 is preferably temperature-controlled to the process temperature range.

Production line 2 is completely enclosed by a housing 65. Preferably, the interior of the housing 65 is temperature-controlled by means of at least one climate control agent to the process temperature range, in particular to a temperature range of 25° C. to 35° C.

FIG. 3 shows a schematic view of an embodiment of a joining station 54 of a production line 2 and an embodiment of a battery housing part 4 arranged in the joining station 54.

In the joining station 54, the base plates 58 are provided by means of a first, preferably movable upper tool half 66. Battery housing receptacles 12 are also provided.

The battery housing receptacles 12 have essentially horizontally extending, plate-shaped base sections 68, which have a plurality of closed (cooling) channels 74 on the surfaces 72 facing away from the receptacle spaces 70 for the battery modules and/or battery cells.

During joining, the battery housing receptacle 12 is preferably pressed against the base plate 58 by means of at least one pressure pad 76 or a plurality of pressure pads 76. The at least one pressure pad 76 does not exert the pressure on the battery housing receptacle 12 directly, but by means of a pressure unit 77 or a second tool half. The at least one pressure pad or the at least one fabric hose 76 can be pressurized with pressure or air, whereby the pressure is indicative of the pressing force or pressing pressure exerted by the at least one pressure pad 76. The amount of pressure applied to the at least one pressure pad 76 is adjustable and/or controllable and can be maintained or adjusted in a e manner during the joining step. Preferably, the compressed air is temperature-controlled so that the at least one pressure pad 76 can enable temperature control during the joining step. The use of at least one pressure pad 76 designed as a fabric hose has proven advantageous in practice in terms of sufficient heating and desired force distribution.

Before the joining step of the battery housing receptacle 12 and the base plate 58, the foam material 42 is inserted between the base plate 58 and the battery housing receptacle 12, which serves in particular to improve the mechanical properties of the battery housing part 4 and to improve the connection between the base plate 58 and the battery housing receptacle 12.

The battery housing part 4 has a frame 14 that at least partially surrounds the battery housing receptacle 12. As previously described in relation to the production line 2, the frame 14 is first connected to the battery housing receptacle 12. For this purpose, the battery housing receptacle 12 has side walls 78 adjoining the plate-shaped bottom section 68 and fastening sections 80 adjoining the side walls 78. The plate-shaped side walls 78 are sealed and/or connected to the frame 14, for example, by means of the foam casting material 32.

The fastening sections 80 are also bonded to the frame 14 on their surfaces facing the frame 14, for example by means of the adhesive seam 18. Adhesive 40 may also be applied to one side surface of the frame 14, whereby the frame 14 can be bonded to the base plate 58 by means of the adhesive 40.

FIG. 4 shows a schematic view of the embodiment of the battery housing part 4 manufactured by the production line 2.

The exemplary embodiments/examples of the present invention described in this specification are to be understood as disclosed both individually and in all combinations with each other. In particular, unless explicitly stated otherwise, the description of a feature included in an embodiment should not be understood to mean that the feature is indispensable or essential for the function of the embodiment. The sequence of the process steps described in this specification is not mandatory; alternative sequences of the process steps are conceivable. The process steps can be implemented in various ways; for example, implementation in software (through program instructions), hardware, or a combination of both is conceivable for implementing the process steps.

Terms used in the patent claims such as “comprise,” “have,” “include,” “contain,” and the like do not exclude further elements or steps. The phrase “at least partially” covers both the case of “partially” and the case of “completely.” The phrase “and/or” should be understood to mean that both the alternative and the combination should be disclosed, i.e., “A and/or B” means “(A) or (B) or (A and B)”. A plurality of units, persons, or the like means, in the context of this specification, multiple units, persons, or the like. The use of the indefinite article does not exclude a plural. A single device may perform the functions of several units or devices mentioned in the patent claims. Reference signs specified in the patent claims are not to be regarded as limitations on the means and steps used.

### REFERENCE SIGN LIST

4 Battery housing part
8 Bearing area for battery housing receptacles
10 Bearing area for frame
12 Battery housing receptacle
14 Frame
16 Adhesive station
18 Adhesive seam
30 Casting station
32 Foam casting material
40 Adhesive
42 Foam material
46 Adhesive device
48 Foam device
54 Joining station
56 Storage unit
58 Base plate
62 Final storage
65 Housing
66 Upper tool half
68 Bottom section
70 Compartment for battery modules/battery cells
72 Surface of the battery housing receptacle
74 (Cooling) channels
76 Pressure pad
77 Pressure unit
78 Side wall
80 Fastening section

1-15. (canceled)

16. A production line for manufacturing battery trays for electrically powered vehicles, comprising:
at least one storage station for storing battery housing receptacles and frames;
at least one connection station operative to connect battery housing receptacles to frames via one or more of: a foam material, an adhesive, or combinations thereof;
at least one storage unit for storing a plurality of base plates;
at least one joining station operative to join base plates to battery housing receptacles having frames connected thereto via one or more of: a foam material, an adhesive, or combinations thereof;
at least one storage warehouse for storing the battery trays; and
at least one climate control device; the at least one climate control device being operative to maintain the temperature at least one of the battery housing receptacles, the frames, or the base plates to within a process temperature range.

17. The production line of claim 16, the at least one climate control device being operative to maintain the temperature at least one of the battery housing receptacles, the frames, or the base plates to within a process temperature range in accordance with one or more of: an open time of a foam material; an open time of an adhesive; a curing time of a foam material; a curing time of an adhesive; or combinations thereof.

18. The production line of claim 16, wherein the production line is at least partially enclosed by at least one housing.

19. The production line of claim 18, wherein the process temperature range is between 25° C. and 55° C..

20. The production line of claim 18, wherein the process temperature range is between 27.5° C. and 50° C.

21. The production line of claim 16, further comprising at least one storage climate element operative to maintain the temperature at least one of the at least one intermediate storage warehouse or the at least one storage warehouse to within a temperature range from 25° C. and 50° C., and wherein at least one of the at least one intermediate storage warehouse or the at least one storage warehouse is designed to be essentially tower-shaped.

22. The production line of claim 21, wherein the at least one storage climate element is operative to maintain the temperature at least one of the at least one intermediate storage warehouse or the at least one storage warehouse to within a temperature range from 30° C. and 45° C.

23. The production line of claim 16, further comprising at least one adhesive station operative to apply at least one adhesive seam comprising an adhesive to battery housing receptacles or frames, the adhesive station being temperature controlled to within the process temperature range, the adhesive station being operative to control the temperature of the adhesive of the adhesive seam to a temperature range between 25° C. and 50° C..

24. The production line of claim 23, wherein the adhesive station is operative to control the temperature of the adhesive of the adhesive seam to a temperature range between 27.5° C. and 35° C.

25. The production line of claim 16, wherein the at least one joining station comprises at least one rotary table having a plurality of receiving areas, the at least one rotary table having at least one joining station climate element for each one of the plurality of receiving areas, the joining station climate elements being operative to maintain the temperature of the receiving areas to within a temperature range between 40° C. and 50° C..

26. The production line of claim 25, wherein each one of the plurality of receiving areas further comprises one or more of: at least one vacuum aligner for aligning the battery housing receptacles within the receiving area; at least one fixation element for fixing the battery housing receptables in place within the receiving area.

27. The production line of claim 16, further comprising at least one casting station operative to cast the battery housing receptacles having frames connected thereto with one or more of: a foam material, a casting agent, or combinations thereof.

28. The production line of claim 16, further comprising at least one adhesive and foam station operative to apply an adhesive or foam material to a battery housing receptacles having frames connected thereto, the adhesive and foam station being temperature controlled to within the process temperature range.

29. The production line of claim 28, wherein the adhesive and foam station is operative to control the temperature of the adhesive or foam material prior to its application to a temperature range between 25° C. and 50° C..

30. The production line of claim 28, wherein the adhesive and foam station is operative to control the temperature of the adhesive or foam material prior to its application to a temperature range between 27.5° C. and 35° C..

31. The production line of claim 16, wherein the joining station further comprises at least one pressure pad, the joining station being operative to join base plates to battery housing receptacles having frames connected thereto via the at least one pressure pad being pressurized with compressed air to apply pressure to press the base plates to the battery housing receptacles having frames connected thereto, the compressed air being temperature controlled to within the process temperature range.

32. The production line of claim 31, wherein the joining station further comprises at least one pressure unit, the at least one pressure pad being configured to indirectly apply pressure to press the base plates to the battery housing receptacles having frames connected thereto via the at least one pressure unit.

33. The production line of claim 31, wherein the joining station further comprises at least one temperature sensor for measuring the temperature at the joining station, and wherein the joining station further comprises at least one controller for controlling at least one of the quantity or temperature of the compressed air within the pressure pad, the controller being operative to control at least one of the quantity or temperature of the compressed air within the pressure pad as a function of the temperature measured by the temperature sensor.

34. A method for manufacturing battery trays for electrically powered vehicles, the method comprising the steps of:
providing a battery housing receptacle and a frame;
connecting the battery housing receptacle to the frame via one or more of: a foam material, an adhesive, or combinations thereof;
providing a base plate;
joining the base plates to the battery housing receptacle having the frame connected thereto via one or more of: a foam material, an adhesive, or combinations thereof; and
maintaining the temperature at least one of the battery housing receptacle, the frame, or the base plates to within a process temperature range in accordance with one or more of: an open time of a foam material; an open time of an adhesive; a curing time of a foam material; a curing time of an adhesive; or combinations thereof.

35. The method of claim 34, wherein the process temperature range is between 25° C. and 55° C.
